(19) United States
(12) Patent Application Publication
(10) Pub. No.: US 2005/0246226 A1
(43) Pub. Date: Nov. 3, 2005

(54) Matching accessories and method of coordinating and selling same

(76) Inventors: Todd Vore, Raleigh, NC (US); Kurt Wineman, Mebane, NC (US)

Correspondence Address: BUCHANAN INGERSOLL PC, 1835 MARKET STREET, 14TH FLOOR, PHILADELPHIA, PA, 19103-2985, US

(21) Appl. No.: 10/834,709

(22) Filed: Apr. 29, 2004

(51) Int. Cl. G06F 17/60; A43B 5/00

(52) U.S. Cl. 705/14

(57) ABSTRACT

The invention is drawn to a method of packaging and selling a group of different accessories that have matching visual features and the accessory package manufactured by the method. At least one set of footwear accessories such as socks is combined with one or more other sets of athletics-related accessories such as shoe laces, insoles, headbands and wristbands based on matching visual indicia such as color, style, texture and/or design, and the matching accessory sets are packaged together for sale.

### FIELD OF THE INVENTION

The present invention relates generally to the field of consumer goods, and specifically to a system and method for coordinating clothing and footwear related accessories based on matching visual features. More specifically, the present invention relates to a system and method for coordinating various athletics-related accessories such as shoe laces, socks insoles, and other goods based on matching color, style, texture and/or design.

### BACKGROUND

Matching clothing and footwear accessories can make an important fashion statement, on and off the playing field. In particular, in the sports and athletic arena, individuals and players are often recognized by their colors or other matching recognizable features—we can tell who plays for what team by what team jersey they are wearing. Often, games and sports are too fast paced for spectators to recognize small print of a team name on athletes' jerseys or other apparel, so colors, and often designs, are used as distinguishing indicia.

For athletes and those who play sports and other activities that generally require “team” or matching uniforms, it may be important to match clothing and footwear accessories with the requisite uniforms and/or footwear. Adding matching socks and shoe laces, as well as headbands and wrist bands, to already existing matching clothing and paraphernalia enhances appearances and team spirit.

Even for those individuals that are avid fans and spectators, it is important and fun to wear the favorite team “colors” to show team support and spirit—the team jacket and favorite player jerseys sold at sporting goods stores and online is not a passing fancy. In Philadelphia, Pa., many a fanatic fan can be seen wearing almost head-to-toe Eagle green on a fall Sunday afternoon, sporting a “McNabb” jersey. Across the state on the same Sunday, downtown Pittsburgh may be teeming with “Steeler” black and gold jerseys, baseball caps, leather jackets, and tassel caps. In general, the ability of those fans to match clothing accessories with their “team” colors will enhance their ensembles and boost their enthusiasm for the home team, whether it is a professional, amateur, high school or little league team.

Tubbs et al. (U.S. Pat. No. 5,967,562) describes a system of color- and style-coordinating clothing using a labeling apparatus. Labels are placed on various consumer items such as socks, t-shirts, handbags, etc. based on the manufacturer's style and color scheme. This method may make it easier for consumers to match clothing and footwear accessories, but does not make it easier for them to purchase them as part of a single package, nor does it work for those consumers that wish to buy particular “team” colors or styles.

It is also well known in the industry to change various parts of clothing and shoes, for example, by varying the colors to match other clothing items. Watches are sold with different color replaceable face covers; costume jewelry rings are sold with different color and style “inserts” to match the rings with the wearer's outfit or mood. As another example, Bryden et al. (U.S. Pat. No. 4,059,910) describe a sandal which allows for changing the material on the upper portion of the sandal to match different clothing and color combinations. However, this is unrelated to a system of selling color-coordinated or otherwise matching footwear and clothing accessories, that are packaged together, to match different footwear and clothing colors, styles, and designs.

### SUMMARY OF THE INVENTION

The present invention is a system and method, and resulting product, of combining and selling matching color- or other feature-coordinated clothing and footwear accessories together, namely, socks and shoe-laces, and other athletic accessories such as insoles, headbands, and wristbands. However, the method of the present invention is not limited by the types of accessories to be matched. The method provides a vehicle for the coordination and efficient sale of matching goods based on a consumer's desired color, style features, and/or other scheme.

At least one footwear accessory is combined with another clothing or footwear accessory that is different from the first footwear accessory. For example, footwear accessories such as socks and shoe laces that match based on one or more visually distinguishing characteristics are coordinated and sold together, which enables consumers to easily purchase matching goods without having to search the local athletic-wear store. At least one footwear accessory may be combined with at least one other clothing or footwear accessory that is althetics-related. The present invention is also drawn to the overall coordinated “package” of matching accessories made according to the present method.

For example, according to one embodiment of the invention, Philadelphia Eagles fans and other semi-professional, amateur, college, high school, etc. team members that wear green and white, will be able to purchase a sock and shoe lace combination in green and white easily without having to search for mismatched goods all over a sporting-goods store. Similarly, red and gold socks and matching shoe laces, with possibly a matching headband and pair of wristbands can be packaged together for sale, the ready consumer being San Francisco 49ers fans, and other athletes and their parents, fans, etc. that desire those colors.

The invention is not limited to color. Other features including but not limited to texture, style, and design are also used to match various accessories for packaging and sale. The invention is also not limited to the types of materials that may be used to manufacture the accessories. Rather it will be understood by those of skill in the art that the invention includes any suitable materials for the various accessories which are grouped together based on one or more matching features.

The resulting group of matching accessories is sold together in a single package, and the multi-accessory packaging according to the present invention enables the sale of the goods together, at a single location, for consumer ease and efficiency.

It will be readily understood by one of skill in the clothing and footwear industry that this method of coordinating and selling matching clothing and footwear accessories is highly advantageous to both merchants and consumers in various industries and not particularly limited to footwear and related goods.

### BRIEF DESCRIPTION OF THE FIGURES

FIG. 1 provides a sample footwear accessory package, featuring matching white socks and shoe-laces with blue features.

### DETAILED DESCRIPTION OF THE INVENTION

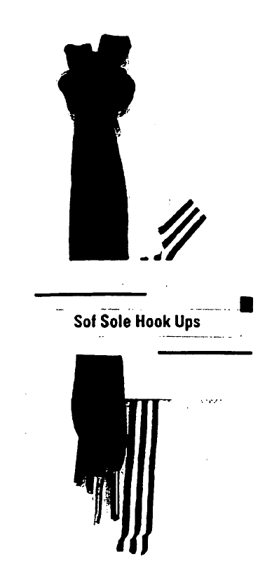

Referring now to the Figure, one embodiment of the present invention uses color as a coordinating visual feature for selling matching footwear accessories. FIG. 1 provides an example of a color-coordinated shoe lace and sock combination 1. The matching color blue appears on both the socks 2 and the shoe laces 3, and both the socks 2 and laces 3 are provided in a single package 4 for ease of display and consumer purchase.

At least one footwear accessory is matched by color, style, texture, and/or any other matching visual feature, with one or more other clothing or footwear accessories, however, no two types of accessories to be matched in a coordinated package are the same, i.e. one pair of socks is not matched with another pair of socks, and one pair of shoe laces is not matched together with another pair of shoe laces. Although size is not considered a matching feature according to this invention, the coordinated accessory combinations can be sold in various sizes. Examples of such accessories according to the present invention are athletics-related goods such as socks, shoe laces, insoles, tights, headbands, wristbands, arm bands, athletic tape, and medical paraphernalia that may be required and worn by athletes while engaging in sports and other athletic activities, and even spectators that wish to take their sports team appreciation that “extra step.”

The particular color, style, pattern, texture, etc. of the goods is not important, rather the coordination and sale of the combination, providing consumers with a one-stop shopping approach to matching footwear accessories with other accessories. The matching accessories are grouped by “sets” that have one or more members which are identical in nature. For example, the individual sets may include two socks, or two shoe laces, or a single headband. Each member in a set has at least one visual feature in common with one or more members in a “matching” other set, which may or may not match the other members of its own set. In other words, two socks contained in a sock set can match each other, i.e. two matching white socks with blue stripes 2, as shown in FIG. 1, however the socks will be coordinated with a different matching set such as the white shoe lace set 3 in FIG. 1. According to another example, one blue sock and one red sock in a set do not match each other but will be coordinated with a matching set of blue shoe laces, red shoe laces or red and blue shoe laces. Importantly, at least two sets are combined in a single package for sale so that no single set of socks, shoe laces, etc., is sold by itself. It is also clear from the example set forth above that that color-coordinated accessories according to the present invention can involve more than one color.

The invention is not limited to the visual feature of color. Matching and coordination can also be by style, texture, pattern, or design including but not limited to stripes, shapes, pictures, figures, drawings, letters, numbers, or any combination thereof. Textures may be used as the matching feature, such as ribbed and smooth socks with shoe laces that are ribbed and wide, and smooth and round, respectively. The invention is not limited to the types of materials that may be used to manufacture the accessories, and it will be understood by those of skill in the art that any suitable materials for socks, shoe laces, insoles, headbands, wristbands, and the like can be used, and the materials of construction can determine the texture of the accessories that becomes a matching visual feature. For example fleece socks, headbands and wristbands packaged together all “match” based on the use of fleece, a generally visually recognizable “fuzzy” material of construction for consumer apparel. ‘Styles’ such as short or long socks and laces, and designs such as tiger-stripes, polka-dots, vertical stripes, and flames can also provide the matching visual features that distinguish accessories according to the current invention that are associated with different sports, and different sports teams or other organizations.

Matching features can also be combinations of two or more features, such as color and style, or color and pattern, or color, pattern, and texture, etc. For example, a footwear accessory set of two white fleece socks that have blue and orange polka dots and a matching set of two thick cotton shoe laces will be packaged and sold together. According to another example, a set of knee high, ribbed, red socks and a set of extra-long, ribbed, red shoe laces, all of which have black stripes will be combined in the same package. Included in that same package can also be a headband and/or two wristbands that are red with black stripes. A roll of red medical tape with black stripes can also be included in one of the packaging groups.

Design logos, initials, etc. are also used as matching visual indicia, such as a gold “R” on a set of purple socks, and the same style “R” printed on purple shoe laces, the most obvious consumer being a Baltimore Ravens football fan.

Referring back to FIG. 1, it is therefore apparent that, for example, the local high school tennis team, whose colors are blue and white, may select this sock 2 and laces 3 combination 1 over non-matching accessories.

Packaging according to the current invention requires that at least one footwear accessory and at least one other matching accessory are held together in a single package. Any type of packaging material and construction that permits this can be used, provided, however, that the matching characteristics of the goods can be viewed by the potential purchaser. As shown in FIG. 1, the packaging 4 is a single-piece-construction cardboard (or other similar material), container that snugly holds an accessory group: a set of socks 2 and a set of shoe laces 3, the two sets which have common visual features. Examples of other suitable packaging materials and styles include, but are not limited to, plastic containers, boxes, bags, and shrink wrap.

It will be understood by those skilled in the art that the invention is not limited to the sale of a specified number of accessory groups per package, as the consumer may desire an ‘economy’ size of goods. Two or more accessory groups of matching socks and shoe laces can be packaged together so that the consumer gets multiple matching accessory groups. According to another example, multiple sets of shoe laces, socks, insoles, headbands, and wristbands that match in color, style, design and/or texture can all be packaged in a single economy-size package.

The invention is not limited by size, and the sets of accessories sold in a single package may be the same or different sizes. For example, a package with one or more accessory groups of socks and shoe laces can have medium sized socks and certain length shoe laces. Alternatively, a package of two matching accessory groups may contain one group of medium socks/matching laces and one group of large socks/matching laces.

The foregoing description provides only an exemplary embodiment of the present invention for the purposes of illustration and not limitation. It will be readily apparent to those skilled in the art that the embodiments described herein may be modified or revised in various ways without departing from the spirit and scope of the invention. The scope of the invention is to be measured by the appended claims.

1. A method for marketing and selling clothing and footwear accessories comprising:
providing a first set of footwear accessories and at least one additional set of clothing or footwear accessories that is different from the first set, each of the first and at least one additional set comprising one or more identical members, wherein at least one member of the first set has a visual feature in common with at least one member of at least one of said additional sets, said visual feature being selected from the group consisting of color, texture, style and design;
combining said first set and said at least one additional set to form a matching accessory group; and
packaging said matching accessory group in a single package to form a coordinated sale item.

2. The method of claim 1 wherein said coordinated sale item comprises more than one matching accessory group.

3. The method of claim 1 wherein said footwear accessories comprise socks.

4. The method of claim 1 wherein said footwear accessories comprise shoe laces.

5. The method of claim 1 wherein said footwear accessories comprise insoles.

6. The method of claim 1 wherein said clothing or footwear accessories comprise athletics-related accessories.

7. The method of claim 6 wherein said athletics-related accessories are selected from the group consisting of socks, shoe laces, insoles, headbands and wristbands.

8. The method of claim 1 wherein the members of said first set are socks and the members of a first of said additional set are shoe laces.

9. The method of claim 8 further comprising a headband and a pair of wristbands.

10. The method of claim 9 wherein said coordinated sale item contains more than one matching accessory group.

11. A feature coordinated accessory package comprising at least one matching accessory group, said matching accessory group comprising a first set of footwear accessories and at least one additional set of clothing and footwear accessories that is different from the first set, each set comprising one or more identical members, wherein at least one member of each first and at least one additional set has at least one visual feature in common with at least one member of at least one of said at least one additional set, said visual feature being selected from the group consisting of color, texture, style and design.

12. The accessory package of claim 11 wherein said footwear accessories comprise socks.

13. The accessory package of claim 11 wherein said footwear accessories comprise shoe laces.

14. The accessory package of claim 11 wherein said footwear accessories comprise insoles.

15. The accessory package of claim 11 wherein said clothing and footwear accessories comprise athletics-related accessories.

16. The accessory package of claim 15 wherein said athletics-related accessories are selected from the group consisting of socks, shoe laces, insoles, headbands and wristbands.

17. A method for marketing and selling clothing and footwear accessories comprising:
providing a first set of footwear accessories, said footwear accessories selected from the group consisting of socks, shoe laces, and insoles, and at least one additional set of clothing and footwear accessories that are different from the first set, wherein the clothing and footwear accessories are selected from the group consisting of athletic socks, shoe laces, insoles, headbands and wristbands, each of the sets comprising one or more identical members, said method comprising:
combining said first set and said at least one additional set to form a matching accessory group wherein at least one member from said first set has at least one visual feature in common with at least one member of at least one of said additional set, wherein said visual feature is selected from the group consisting of color, texture, style and design, and
packaging said matching accessory group in a single package to form a coordinated sale item.

18. The method of claim 17 wherein said coordinated sale item comprises more than one matching accessory group.
